(19) United States
(12) Patent Application Publication
(10) Pub. No.: US 2021/0241255 A1
(43) Pub. Date: Aug. 5, 2021

(54) METHOD, APPARATUS AND SYSTEM TO ACCESS SECURE LINKED ACCOUNT INFORMATION

(71) Applicant: MASTERCARD INTERNATIONAL INCORPORATED, Purchase, NY (US)

(72) Inventors: Gary Adler, Teaneck, NJ (US); Suman Rausaria, Ballwin, MO (US); Harish Pindolia, Edgware (GB)

(73) Assignee: MASTERCARD INTERNATIONAL INCORPORATED, Purchase, NY (US)

(21) Appl. No.: 16/778,747

(22) Filed: Jan. 31, 2020

(51) Int. Cl. G06Q 20/32; G06Q 20/38; G06Q 20/10

(52) U.S. Cl. CPC G06Q 20/3223; G06Q 20/102; G06Q 20/3821

(57) ABSTRACT

Systems, apparatuses and methods may provide for technology to determine that first details associated with a first electronic payment process are absent and identify that second details are selected by a user. The second details may be associated with a second electronic payment process and further the second details may be associated with the first details. The technology may also determine that the first details are to be retrieved based on the second details and cause the second details to be transmitted.

### FIELD

The present disclosure relates generally to linked account information, and more particularly, apparatus, methods and systems to retrieve first payment details associated with a first electronic payment process based on second payment details associated with a second electronic payment process.

### BACKGROUND

Due to the advent of technology, cashless modes of payments have experienced an upward trend in use. Customers find the cashless modes of payments more convenient, as they do not have to carry cash with them for making purchases. Due to the convenience offered by the cashless modes of payments to the customers and merchants, merchants may accept cashless payments at physical locations of stores (e.g., store fronts).

In some cases, a merchant may desire a particular form of electronic payment process (e.g., ACH transfer) to consummate a transaction with a customer. The customer may not have the payment details (e.g., bank information, account information, routing information, sort number, etc.). Thus, the customer may need to pay with a less desirable form of payment (e.g., cash, credit cards, debit cards, etc.), or the customer will be unable to purchase products from the merchant. In some cases, utilizing the less desirable form of payment may also be inefficient as doing so may incur surcharges and fees.

In some cases, the customer may be able to manually enter the payment details into an application to facilitate payment. Doing so however is cumbersome such that some customers may decline to enter the payment details. Furthermore, manual entry of the payment details may not be possible if the customer does not readily have the payment details available. Thus, merchants may fail to consummate some transactions due to customers inability or lack of motivation to provide payment. Moreover, manual entry of the payment details may result in theft of sensitive information if malicious characters observe the entry of the payment details. As such, manual entry of the payment details may be undesirable for the aforementioned reasons.

In light of the foregoing, there exists a need for a solution for facilitating identification of the payment details while also enhancing safety and convenience.

### SUMMARY

Various embodiments of the present disclosure provide methods and systems for managing transactions with enhanced efficiency and security.

Some embodiments relate to a computing system, comprising one or more network interfaces, and one or more processors that are configured to determine an absence of first details associated with a first electronic payment process, identify a selection of second details by a user, wherein the second details are associated with a second electronic payment process, further wherein the second details are associated with the first details, determine that the first details are to be retrieved based on the second details and cause at least part of the second details to be transmitted via the one or more network interfaces.

Some embodiments relate to at least one computer readable storage medium comprising a set of instructions, which when executed by a computing device, cause the computing device to determine an absence of first details associated with a first electronic payment process, identify a selection of second details by a user, wherein the second details are associated with a second electronic payment process, further wherein the second details are associated with the first details, determine that the first details are to be retrieved based on the second details and cause at least part of the second details to be transmitted.

Some embodiments relate to a method comprising determining an absence of first details associated with a first electronic payment process, identifying a selection of second details by a user, wherein the second details are associated with a second electronic payment process, further wherein the second details are associated with the first details, determining that the first details are to be retrieved based on the second details and causing at least part of the second details to be transmitted.

Other aspects and example embodiments are provided in the drawings and the detailed description that follows.

### BRIEF DESCRIPTION OF THE DRAWINGS

The accompanying drawings illustrate various embodiments of systems, methods, and other aspects. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments are illustrated by way of example, and not limited by the appended figures, in which like references indicate similar elements, and in which:

FIGS. 1A and 1B illustrate a payment process that includes remote retrieval of payment details in accordance with some embodiments;

FIG. 2 is a process flow diagram that illustrates determining that first payment details may be retrieved based on second payment details, in accordance with some embodiments;

FIG. 3 illustrates an execution of a retrieval and transaction process in accordance with some embodiments;

FIG. 4 is a process flow diagram that illustrates a method for securely presenting retrieved payment details, in accordance with some embodiments;

FIG. 5 is a process flow diagram that illustrates a method for retrieving multiple payment details, in accordance with some embodiments;

FIG. 6 is a process flow diagram that illustrates a method for providing payment details, in accordance with some embodiments;

FIGS. 7A and 7B illustrate an on-boarding process that includes an evolution of a graphical user interface in accordance with some embodiments; and

FIG. 8 is a block diagram of a computing device, in accordance with some embodiments.

Further areas of applicability of the present exemplary embodiments will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example” and so on, indicate that the embodiment (s) or example (s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### OVERVIEW

In various exemplary scenarios, a customer may want to purchase products and/or services from a merchant. To consummate the transaction, the customer may need to execute payment. The merchant may request that the customer provide payment through a first electronic payment process that is executed based on first payment details. The customer may have an application to execute the payment, but the application may not have the first payment details stored.

The application may have access to second payment details associated with a second electronic payment process. That is, the application may execute the second electronic payment process based on the second payment details.

The second payment details may be linked to the first payment details. For example, the second payment details may be a debit account information, while the first payment details may be a routing number, sort number, checking account number and/or other unique identifier. Thus, both the first payment details and the second payment details may identify a same bank account and are linked via the same bank account. That is, the first and second payment details may both be associated with a same bank account. Thus, some embodiments retrieve the first payment details based on the second payment details and through analysis of related payment details.

Some embodiments may also result in a positive customer experience due to the reduced effort of retrieving the first payment details. Furthermore, some embodiments enhance security by preventing the possibility of malicious actors observing such manual entry and copying the first payment details. Moreover, the above process may allow customers who do not have the first payment details readily available to nonetheless seamlessly and securely obtain the first payment details to enhance the probability that the customer can consummate a transaction with ease and efficiency. Further, the embodiments may enhance power usage and resource management of the customer's device by avoiding lengthy interactions with a mobile device to facilitate payment. For example, the embodiments may be executed in seconds, as opposed to manual entry which may take several minutes draining the power of consumers' mobile devices and utilizing excessive resources.

### TERMS DESCRIPTION (in Addition to Plain and Dictionary Meaning)

Server is a physical or cloud data processing system on which a server program runs. A server may be implemented in hardware or software, or a combination thereof. In one embodiment, the server includes a computer program that is executed on programmable computers, such as personal computers, laptops, or a network of computer systems. The server may correspond to a merchant server, an acquirer server, a payment network server, an issuer server, or a digital wallet server.

Merchant is an entity that offers various products and/or services in exchange of payments. The merchant may establish a merchant account with a financial institution to accept payments from several customers.

Issuer is a financial institution where accounts of several customers are established and maintained. The issuer ensures payment for authorized transactions in accordance with various payment network regulations and local legislation.

Payment network is a transaction card association that acts as an intermediate entity between acquirers and issuers to authorize and fund transactions. Examples of payment networks include Mastercard®, American Express®, VISA®, Discover®, Diners Club®, and the like. The Payment network settles transactions between various acquirers and issuers, when transaction cards are used for initiating transactions. The payment network ensures that a transaction card used by a customer for initiating a transaction is authorized.

Digital enablement service allows issuers and merchants to manage tokenization and digitization to enhance security for every transaction.

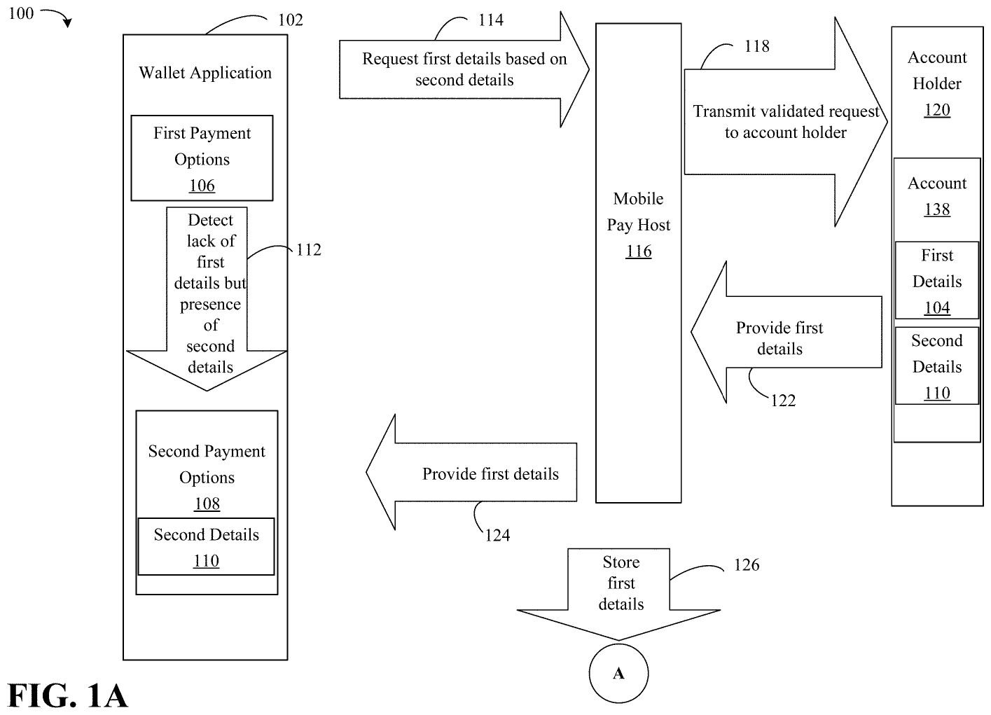

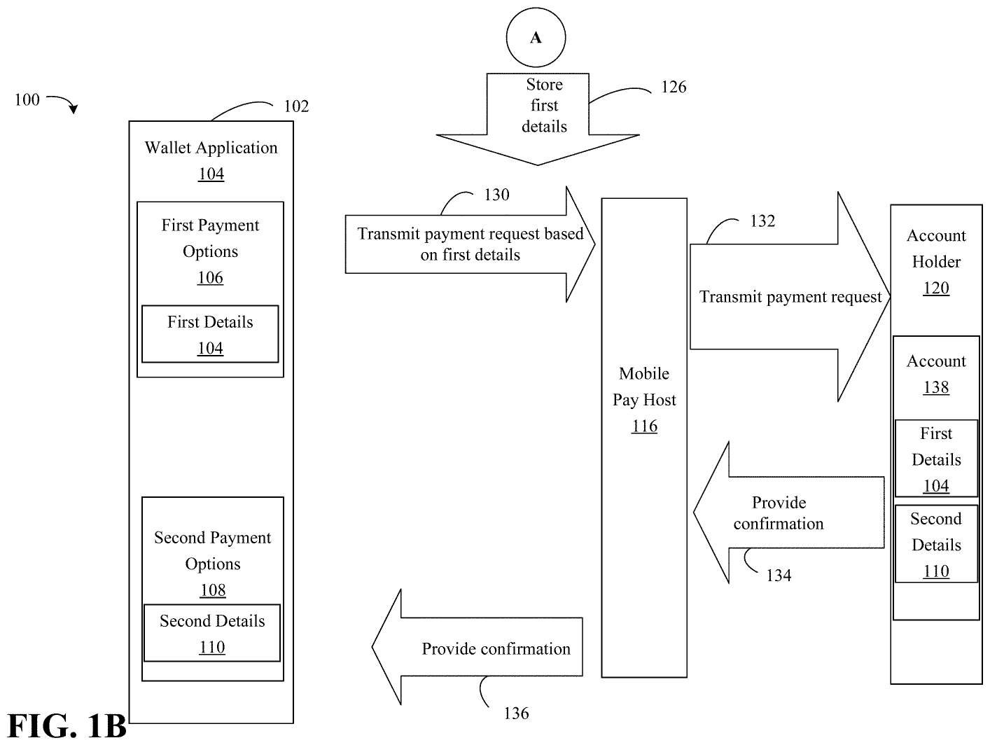

Mobile pay host may be a backend system that includes application programming interfaces (APIs) to facilitate access to, enabling of payment-related products including registration, provisioning and processing payment-related products and services. Various exemplary embodiments have been further described in detail with reference to FIGS. 1 to 8.

FIGS. 1A and 1B illustrate a process 100 to execute a payment based on first payment details 104 (referred to as first details for brevity). As illustrated a wallet application 102 may include different payment options. In detail the different payment options include first payment options 106 (e.g., bank account payment such as Automated Clearing House payments) that select a first electronic payment process and second payment options 108 (e.g., debit card transaction and/or credit card transactions) that select a second electronic payment process. The wallet application 102 may require further payment details (e.g., routing number, debit card number, bank account, sort code, tokens, etc.) in order to execute the first and second electronic payment processes.

In this particular example, a user may select the first payment options 106. The wallet application 102 may detect that the first payment options 106 do not include any payment details (an absence of payment details) and therefore that further information is needed to execute the first electronic payment process.

In order to do so, the wallet application 102 may determine whether other available information may be linked to the first payment options 106. In this example, the wallet application 102 may detect that the second payment options 108 may be linked to the first payment options 106. That is, the wallet application 102 may detect that the second payment options 108 and the first payment options 106 may trigger first and second electronic payment processes that withdraw funds from bank accounts. It is worthwhile to note that the first electronic payment process may use a first network to access a bank account, and the second electronic payment process may use a second network (different from the first network) to access the same bank account.

In this example, the wallet application 102 identifies a presence of second details 110, 112. The first details 104 and second details 110 may be related to each other in that both the first and second details 104, 110 may access a unified account 138 to provide payment.

The wallet application 102 may then determine that the first details 104 may be retrieved based on the second details 110. For example, the wallet application 102 may determine that while no payment details exist for the first payment options 106, details do exist for the second payment options 108. As noted, the wallet application 102 may further determine that the first payment options 106 may be related to the second payment options 108 in that both the first and second payment options 106, 108 access the same accounts. The first payment options 106 may utilize a first electronic payment process (e.g., ACH transfer) to access the accounts, while the second payment options 108 may utilize a second electronic payment process (debit and/or credit) to access the accounts. Thus, the wallet application 102 may determine that the first payment options 106 may be populated based on the second payment options 108.

As such, when the user selects the first payment options 106, the wallet application 102 may present account information (e.g., a bank, debit card number, etc.) of the second details 110 to a user. The user may review the presentation of the account information of the second payment options 108 and select a particular account. The account information may identify a particular bank that holds a bank account. For example, at least part of the second details 110 may identify the account 138 (e.g., a checking account), and the account information may include an identifier of the account holder 120 (e.g., bank icon, account number, nickname, etc.) that holds the account 138.

In this example, the user may select the account information of the second details 110. Therefore, the wallet application 102 requests the first details 104 based on the second details 110, 114. For example, the wallet application 102 may provide at least part of the second details 110 (e.g., a token, encrypted version, debit card number etc.) that identifies the account 138 to a mobile pay host 116. The request may further include an identification that details associated with the first electronic payment process should be provided. The mobile pay host 116 may be a back end of the wallet application 102 and may execute API calls to facilitate execution of requests from the wallet application 102.

It is worthwhile to note that at this point, the wallet application 102 may be generally aware that the first details 104 are likely to exist, but be unaware of the specific nature (e.g., the exact routing number, sort number, account number, etc.) of the first details 104. That is, the wallet application 102 may simply identify that the first details 104 are likely to exist based on the existence of the second details 110. For example, the wallet application 102 may determine that the account 138 is available based on the identification of the second details 110 in the second payment options 108, and therefore that it is likely that a first electronic payment process may be executed to access the account 138. Thus, the wallet application 102 may determine that specifics of the first details 104 should be retrieved to facilitate the first electronic payment process.

The mobile pay host 116 may validate the user data and the at least the part of the second details 110. For example, the mobile pay host 116 may perform checks to verify that the request originated from the wallet application 102 of the user. The mobile pay host 116 may transmit the validated request to the account holder 118, 120 (e.g., a bank or financial institutions) of the second details 110. The account holder 120 may receive the request including the identification of the second details 110.

The account holder 120 may perform further validation checks to verify the authenticity of the request (e.g., one-time pin verification process, challenge questions to a user, etc.). When the validation checks are satisfied, the account holder 120 determines that account 138 is associated with the second details 110. That is, the at least the part of the second details 110 identify the account 138. For example, a second electronic payment process may execute based on the at least the part of the second details 110 to access the account 138 for payment.

The account holder 120 may further determine that the first details 104 are associated with the account 138 and identify the account 138. For example, the account holder 120 may determine that a first electronic payment process may execute based on the first details 104 to access the account 138 for payment. Thus, the account holder 120 may determine that the first details 104 satisfy the request. That is, the request may call for details to execute first electronic payment process, and the account holder 120 may determine that the first details 104 correspond to the requested details.

The account holder 120 may then provide the first details 104, 122 to the mobile pay host 116. The mobile pay host 116 may then provide the first details 104, 124 to the wallet application 102. The wallet application 102 may then store the first details 104, 126. The process 100 continues to FIG. 1B.

As illustrated, the first payment options 106 may include the first details 104 that are received from the account holder 120. At this point, the user may be able to review and authorize payment based on the first details 104. After doing so, the wallet application 102 may cause the first electronic payment process to be executed based on the first details 104. For example, the wallet application 102 may transmit a payment request (e.g., a request to pay a merchant) based on the first details 104, 130. For example, the wallet application 102 may transmit a token that corresponds to the first details 104 to provide payment for a transaction. In detail, the transmission may be part of the first electronic payment process and may be based on the first details 104. The mobile pay host 116 may then transmit the payment request 132 to the account holder 120, 132. The account holder 120 may process the payment request and then provide a confirmation of payment 134 to the mobile pay host 116. The mobile pay host 116 may in return provide confirmation 136 to the wallet application 102. The wallet application 102 may provide confirmation of the payment to the user and/or surrounding devices so that a sales transaction may be consummated.

In some embodiments, the wallet application 102 may execute at a computing device (e.g., mobile device, server, etc.). The process 100 may further be executed in response to a request for payment at a store-front and/or at the specific request of a user. Furthermore, the first and second electronic payment processes may be cashless technologies. Additionally, the wallet application 102 may be a mobile wallet technology that executes a mobile payment (e.g., mobile wallets and mobile money transfers) that are regulated transactions that take place through a user's mobile device.

Furthermore, the first details 104 and the second details 110 stored on the wallet application 102 may include various data. For example, the first details 104 may include an identification of the account holder 120, a value of the account 138, a first token to access the account 138, etc. Likewise, the second details 110 may include an identification of the account holder 120, a value of the account 138, a second token to access the account 138, etc.

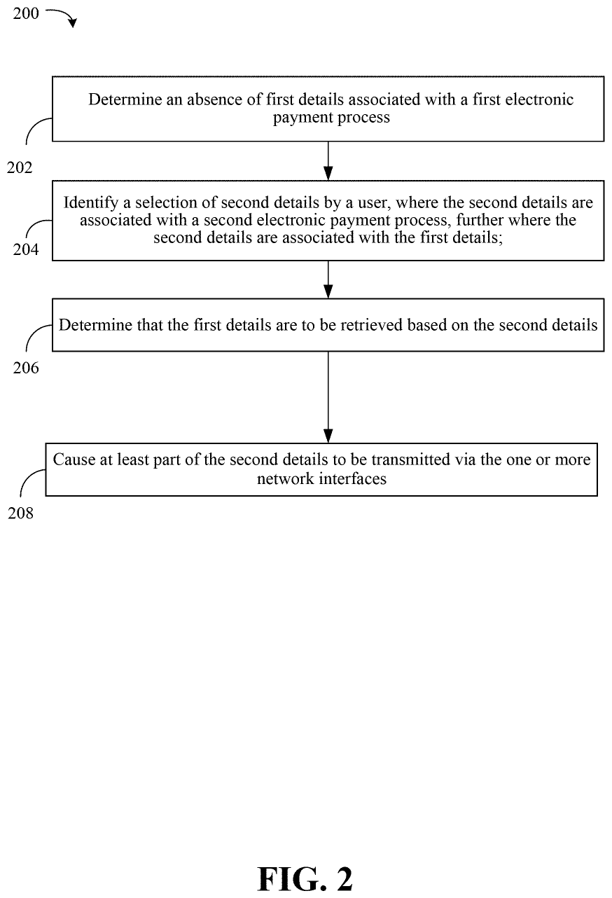

FIG. 2 is a method 200 that illustrates a retrieval process to retrieve payment details, in accordance with an exemplary embodiment. Method 200 may be implemented in at least one computer readable storage medium comprising a set of instructions, which when executed by a computing device, cause the computing device to execute the following steps. In some embodiments, process flow diagram 200 may be executed by hardware elements (e.g., circuitry, fixed-function logic hardware, configurable logic, etc.). In some embodiments, method 200 may be implemented in combinations of hardware elements and software. Method 200 may be implemented by a mobile computing device for example.

Illustrated processing block 202 determines an absence of first details associated with a first electronic payment process. Illustrated processing block 204 identifies a selection of second details by a user. The second details are associated with a second electronic payment process. The second details are associated with the first details. Illustrated processing block 206 determines that the first details are to be retrieved based on the second details. Illustrated processing block 208 causes the second details to be transmitted via the one or more network interfaces.

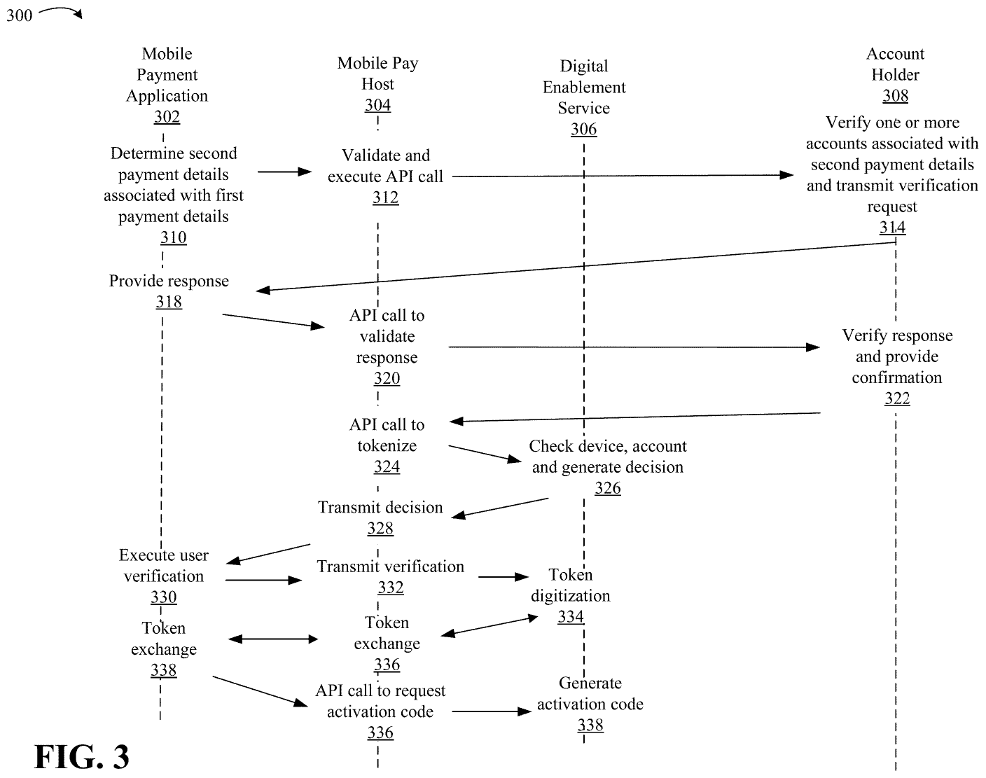

FIG. 3 illustrates an execution of a payment detail retrieval and transaction process 300. Process 300 may be implemented in at least one computer readable storage medium comprising a set of instructions, which when executed by a computing device, cause the computing device to execute the following steps. In some embodiments, process flow diagram 300 may be executed by hardware elements (e.g., circuitry, fixed-function logic hardware, configurable logic, etc.). As illustrated, various actions may be taken by various actors. A mobile payment application 302, mobile pay host 304, digital enablement service 306 and mobile pay host 308 may execute various actions. The embodiments of FIG. 3 may be readily combined and/or included in any of the various embodiments described herein, including the process 100 (FIGS. 1A and 1B) and the method 200 (FIG. 2).

The mobile payment application 302 determines second payment details associated with first payment details 310. As already described, a first electronic payment process may execute based on the first payment details and a second electronic payment process may execute based on the second payment details. The mobile payment application 302 may determine that the specifics of the first payment details are not currently accessible by the mobile payment application 302. Thus, the mobile payment application 302 may request the first payment details. The mobile pay host 304 may validate the request and execute an API call 312.

The mobile pay host 304 may then provide the request to the account holder 308 who may verify the one or more accounts associated with the second payment details and transmit a verification request 314. For example, the account holder 308 may transmit a one-time pin to a device associated with a customer of the account holder 308, ask for replies to challenge, etc. to verify that the request is legitimate and originated from the customer.

The user may provide a response 318 through the mobile payment application 302. The mobile pay host 304 may validate the response and execute an API call 320. The account holder 308 may verify that the response is correct and provide a confirmation 322 to the mobile pay host 304. The confirmation 322 may include the first payment details. The mobile pay host 304 may execute an API call to tokenize 324 the first payment details. The digital enablement service 306 may then check that a computing device that executes the mobile payment application 302 meets device requirements, verifies that the account (e.g., checking account) identified by the first payment details may be digitally stored, and generates a decision 326. In this particular example, the decision is that the account and device comply with the requirements.

The digital enablement service 306 then transmits the decision to the mobile pay host 304, who transmits the decision 328 to the mobile payment application 302. The mobile payment application 302 may then execute a user verification 330 of the first payment details. For example, the decision may include an identification of the first payment details. The identification may be presented to the user so that the user may verify that the account associated with the first payment details is to be used for payments. The mobile pay host 302 may also request that the user verifies conditions to use the first payment details and accepts such conditions. The mobile pay host 304 may transmit the verification 332 to the digital enablement service 306. The digital enablement service 306 executes token digitization 334 to generate a token for the first payment details.

The mobile pay host 304 and mobile payment application 302 may execute token exchanges 336, 338 with each other to execute transactions for payments. The digital enablement service 306 may provide the token to the mobile pay host 304 and/or the mobile payment application 302. The mobile pay host 304 may execute an API call to request an activation code 336, and the digital enablement service 306 may generate the activation code 338.

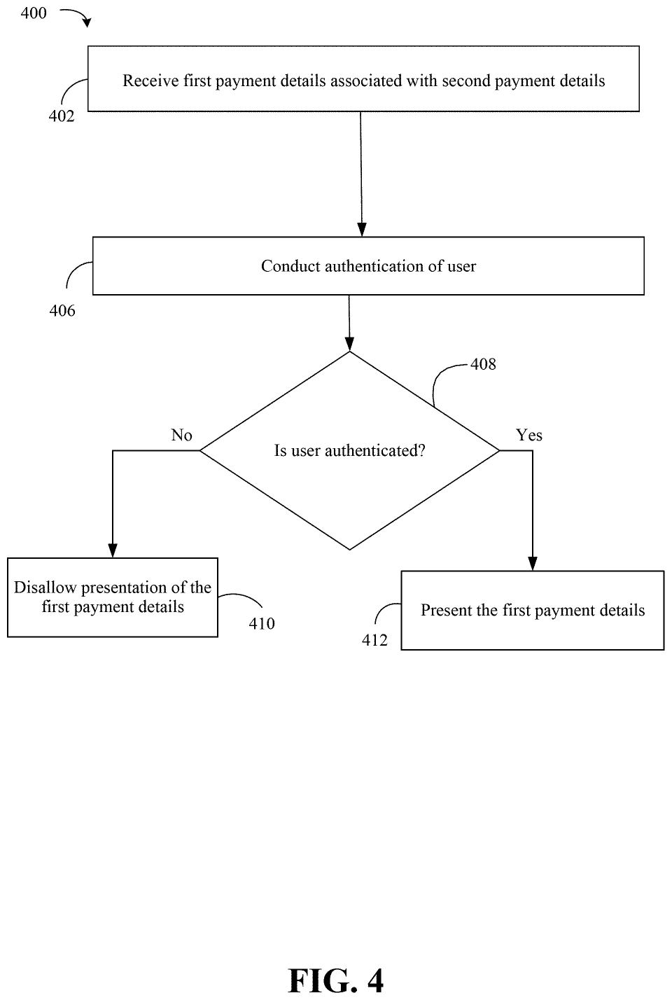

FIG. 4 illustrates a method 400 of securely presenting retrieved payment details. Method 400 may be implemented in at least one computer readable storage medium comprising a set of instructions, which when executed by a computing device, cause the computing device to execute the following steps. In some embodiments, the method 400 may be executed by hardware elements (e.g., circuitry, fixed-function logic hardware, configurable logic, etc.). The embodiments of FIG. 4 may be readily combined with any of the embodiments described herein, including the process 100 (FIGS. 1A and 1B), the method 200 (FIG. 2) and the process 300 (FIG. 3). Method 400 may be executed at a mobile device of a user.

Illustrated processing block 402 receives first payment details associated with second payment details. As described, the first and second payment details may be associated with different electronic payment processes and access a same account. Illustrated processing block 406 conducts an authentication of a user. For example, the computing device may verify that a party that is accessing the mobile device, is the user. Various forms of authentication may be utilized, such as fingerprint verification, facial recognition, pin verification etc. In doing so, the computing device may enhance security by concealing the first payment details should the user not be verified. The verification may be executed locally at the computing device (e.g., based on locally stored verification, results of the authentication unlock features of the computing device, and/or the results are maintained locally and not transmitted to other third-parties).

Illustrated processing block 408 determines whether the user is authenticated. If so, illustrated processing block 412 presents the first payment details to the authenticated user. Otherwise, illustrated processing block 410 disallows presentation of the first payment details.

The first payment details may be sensitive in nature. For example, the first payment details may include personal information, account balances, checking number, routing number, sort codes, etc. If a malicious actor gained access to the first payment details, the first payment details may be maliciously used for nefarious purposes. Thus, the above method 400 verifies and authenticates the user to mitigate the possibility that a malicious actor gained access to a user's unlocked computing device and requested the first payments for unauthorized purposes as exemplified in processing block 410.

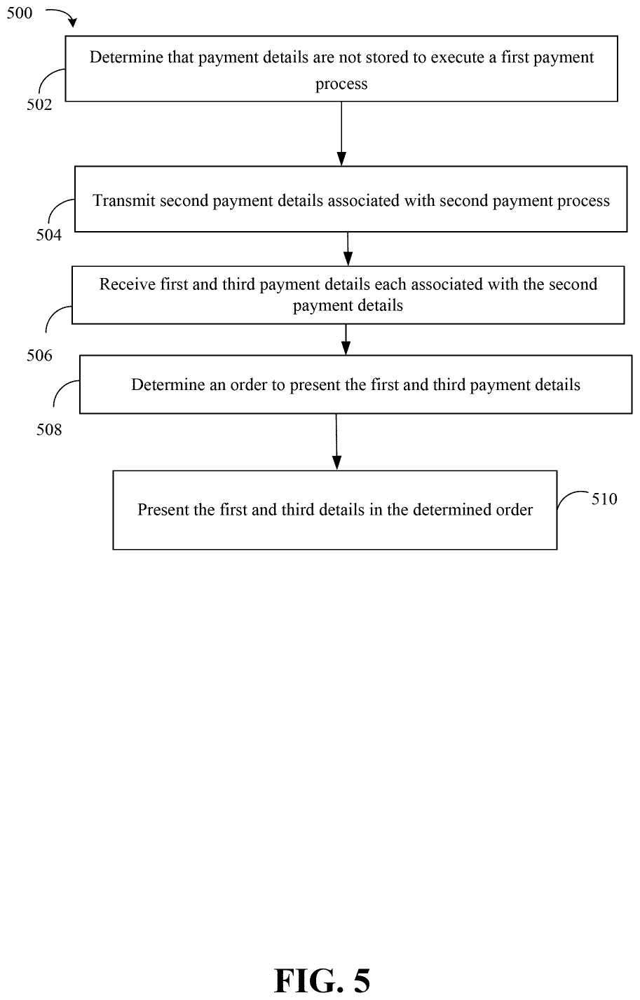

FIG. 5 illustrates a method 500 of retrieving multiple payment details. Method 500 may be implemented in at least one computer readable storage medium comprising a set of instructions, which when executed by a computing device, cause the computing device to execute the following steps. In some embodiments, the method 500 may be executed by hardware elements (e.g., circuitry, fixed-function logic hardware, configurable logic, etc.). The embodiments of FIG. 5 may be readily combined with any of the embodiments described herein, including the process 100 (FIGS. 1A and 1B), the method 200 (FIG. 2), the process 300 (FIG. 3) and the method 400 of FIG. 4.

Illustrated processing block 502 determines that payment details are not stored to execute a first payment process. Illustrated processing block 504 transmits second payment details associated with a second payment process. Illustrated processing block 506 receives first and third payment details that are each associated with the second payment details. For example, the second payment details may provide access to a bank account via the second electronic payment process. In some embodiments, the bank account may be accessed based on one of the first and third payment details as well. That is, the first electronic payment process may execute based on the first payment details, or alternatively the first electronic payment process may execute based on the third payment details.

In some embodiments, the first and second payment details may each correspond to a same first bank account, while the third payment details may correspond to a different second bank account related to the first bank account. For example, the first and second bank accounts may be maintained at a same bank. The first bank account may be identified based on the second payment details, and the second bank account may be identified as being related to the first bank account (e.g., same user(s) own the first and second bank accounts).

Illustrated processing block 508 determines an order to present the first and third payment details. For example, the order may be determined based on usage parameters. The usage parameters may include frequency of use (e.g., payments), number of accesses, current monetary account values, geolocation trends (e.g., user usually executes transactions based on first or third payment details when in a particular area or store, etc.), to present the most relevant ones of the first or third payment details before less relevant payment details (e.g., a list ordered to present the most relevant payment details before less relevant payment details). For example, if the first payment details are more relevant than the third payment details, the first payment details may be presented before the third payment details. Thus, the list may be ordered based on a probability that the user will select the payment details. The probability may be determined based on the usage parameters.

Illustrated processing block 510 presents the first and third details in the determined order 510. Method 500 may be executed at a mobile device of a user.

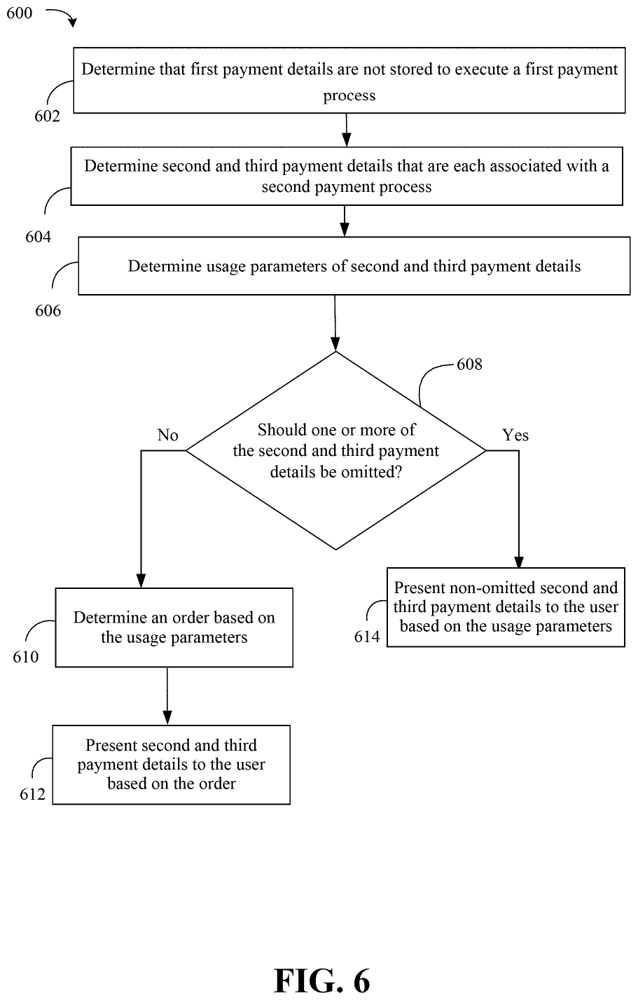

FIG. 6 illustrates a method 600 of providing payment details (associated with a second electronic payment process) that will be utilized to retrieve other payment details associated with a first electronic payment process. Method 600 may be implemented in at least one computer readable storage medium comprising a set of instructions, which when executed by a computing device, cause the computing device to execute the following steps. In some embodiments, the method 600 may be executed by hardware elements (e.g., circuitry, fixed-function logic hardware, configurable logic, etc.). The embodiments of FIG. 6 may be readily combined with any of the embodiments described herein, including the process 100 (FIGS. 1A and 1B), the method 200 (FIG. 2), the process 300 (FIG. 3), the method 400 (FIG. 4) and the method 500 (FIG. 5). Method 600 may be executed at a mobile device of a user.

Illustrated processing block 602 determines that first payment details are not stored to execute a first payment process. Illustrated processing block 604 determines second and third payment details that are each associated with a second payment process. That is, the second payment process may execute based on the second payment details (and not necessarily the third payment details), and the second payment process may execute based on the third payment details (and not necessarily the second payment details). The second and third payment details may correspond to different bank accounts.

Illustrated processing block 606 determines usage parameters. For example, the usage parameters may include frequency of use (e.g., payments) of the second and third payment details respectively, number of accesses to accounts of the second and third payment details respectively, current monetary account values of accounts of the second and third payment details respectively, geolocation trends (e.g., user usually executes transactions based on second or third payment details when in a particular area or store, etc.), to present the most relevant ones of the second or third payment details before less relevant payment details (e.g., a list ordered to present the most relevant payment details before less relevant payment details) and/or omit one or more of the second or third payment details from presentations to the user (discussed below). Thus, the list may be ordered based on a probability that the user will select the payment details. The probability may be determined based on the usage parameters.

For example, if the second payment details are more relevant than the third payment details, the second payment details may be presented before the third payment details. As one example, the user may execute more transactions based on the second payment details than the third payment details, a monetary account value of the second payment details may be higher than a monetary value of the third payment details and/or the user is located in a store in which the user typically uses the second payment details but not the third payment details, etc. so that the order will list the second payment details before the third payment details.

Illustrated processing block 608 determines whether one or more of the second and third payment details should be omitted. For example, if an account balance of one of the second or third payment details is below a threshold (e.g., negative balance, below a monetary value, insufficient amount to pay for an identified purchase the user intends on executing), illustrated processing block 608 omits the one of the second or third payment details. For example, a request to consummate a transaction may trigger method 600 to execute. The transaction may include an identified value for payment that is required to consummate the transaction. The mobile device may store that identified value, check each account balance against the identified value and omit payment details from presentation to the user if the account balance of the payment details is equal to or less than the identified value. In doing so, processing block 608 may protect a user from incurring overage charges and/or receiving a declination of payment for the transaction. In some embodiments, illustrated processing block 608 omits payment details if the payment details correspond to an account that has been declined for payment within a time frame (e.g., within the past few days).

If none of the second and third payment details are omitted, illustrated processing block 610 determines an order to present the second and third payment details based on the usage parameters. For example, if the second payment details are more relevant than the third payment details, the second payment details may be presented before the third payment details. As one example, the user may execute more transactions based on the second payment details than the third payment details, a monetary account value of the second payment details may be higher than a monetary value of the third payment details and/or the user is located in a store in which the user typically uses the second payment details but not the third payment details, etc. so that the order will list the second payment details before the third payment details. Illustrated processing block 612 presents the second and third payment details to the user based on the order

If one of the second and third payment details are omitted, illustrated processing block 6144 presents the non-omitted second and third payment details to the user based on the usage parameters. Thus, the method 600 may mitigate the possibility of the user selecting payment details that are undesirable. While not illustrated, the method 600 may further include retrieving other payment details based on a selected one of the second or third payment details.

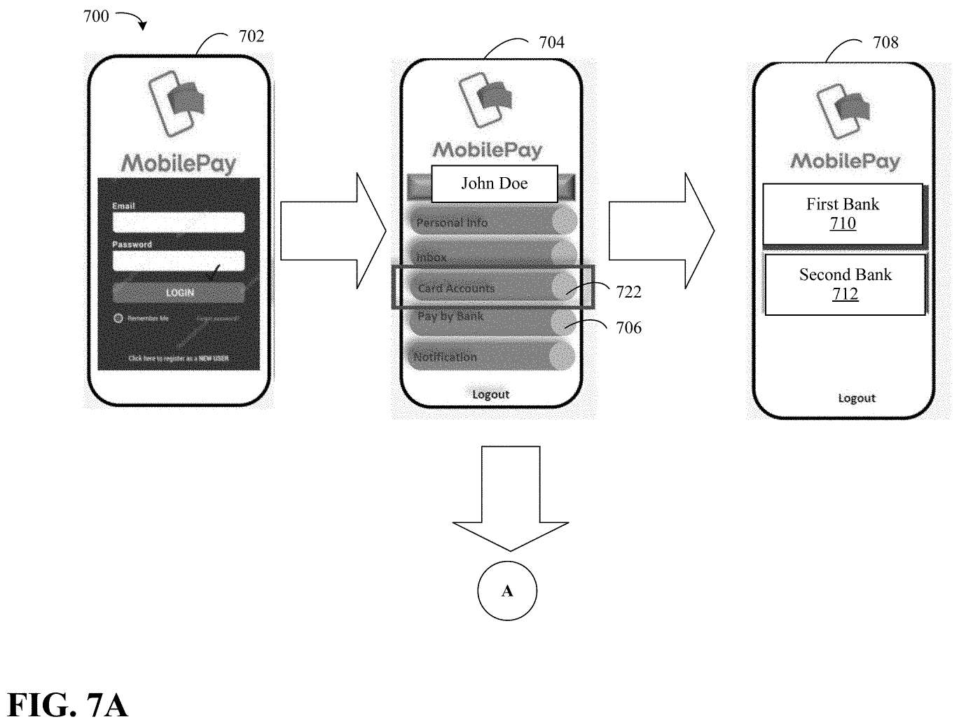

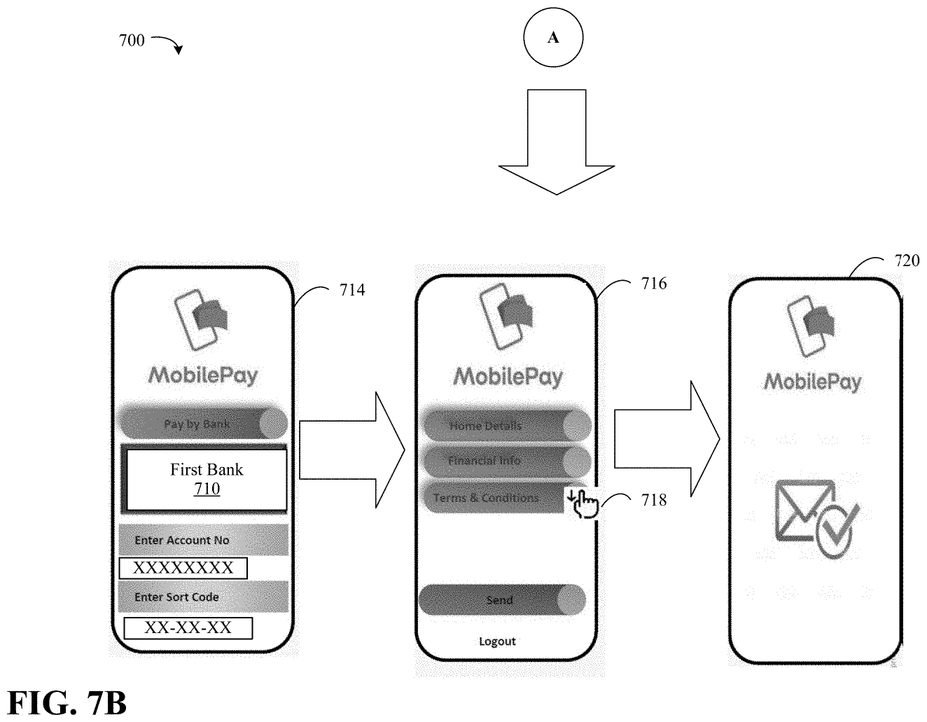

FIGS. 7A and 7B illustrate an on-boarding process 700 that illustrates the evolution of a graphical user-interface of a mobile pay application. The embodiments of FIGS. 7A and 7B may be readily combined with any of the embodiments described herein, including the process 100 (FIGS. 1A and 1B), the method 200 (FIG. 2), the process 300 (FIG. 3), the method 400 (FIG. 4), the method 500 (FIG. 5) and the method 600 (FIG. 6). Process 700 may be executed at a mobile device of a user.

The graphical user interface 702 first logs in and authenticates a user. The graphical user interface 704 then presents different payment options to pay for a transaction (e.g., a current transaction). In this particular example, the user selects the pay by bank option 706. There may be no associated payment details (e.g., first payment details) for the pay by bank option. Thus, graphical user interface 708 may illustrate different first and second banks 710, 712 that are determined from the payment details (e.g., second payment details) of the card accounts 722. For example, the first bank 710 may correspond to second payment details for a first bank account, and the second bank 712 may correspond to third payment details for a second bank account different from the first bank account. The user may be prompted to select one of the first bank 710 (which will select the first bank account) and the second bank 712 (which will select the second bank account).

As shown in FIG. 7B, the user selects the first bank 710 to select the first bank account. While not illustrated, the mobile pay application retrieves the payment details for the first bank account as described herein. The graphical user interface 714 displays the payment details (e.g., account number, bank information, sort code, etc.) for the first bank account. The graphical user interface 716 then provides conditions that the user may need to review and authorize. For example, the user may need to review the terms and conditions 718 and agree to the terms and conditions 718. The mobile pay application may then consummate the transaction, and graphical user interface 720 provides confirmation of the payment.

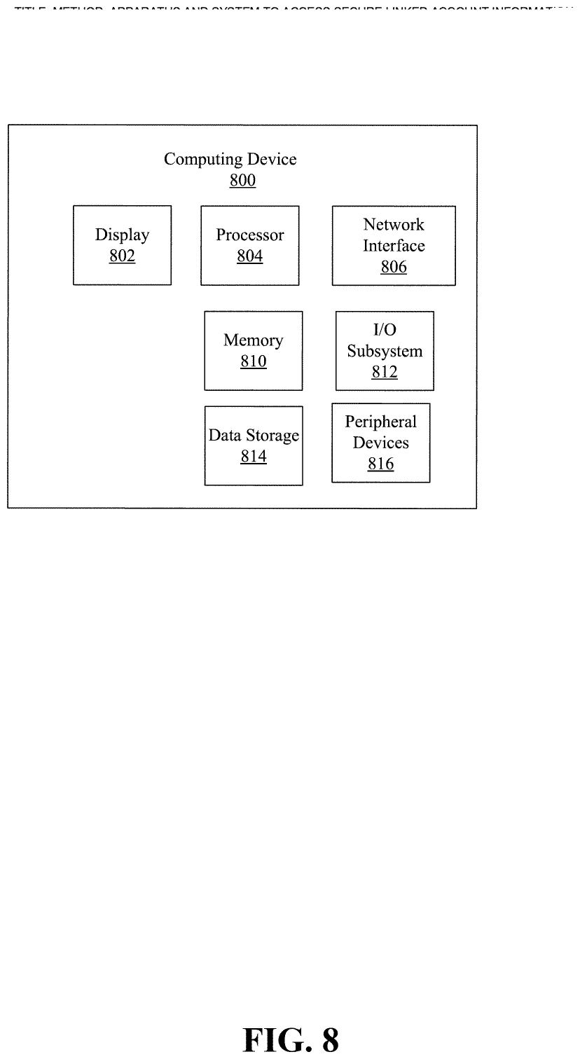

FIG. 8 is a block diagram that illustrates a computing device 800 (e.g., a mobile device). The computing device 800 may implement the process 100 (FIGS. 1A and 1B), the method 200 (FIG. 2), the process 300 (FIG. 3), the method 400 (FIG. 4), the method 500 (FIG. 5), the method 600 (FIG. 6) and the method 700.

The processor 804 includes suitable logic, circuitry, and/or interfaces to execute operations for facilitating electronic transactions and validations performed by using various electronic payment modes, such as transaction cards or e-wallets (e.g., wallet application). The processor 804 performs such operations by means of hardware techniques, and/or under the influence of program instructions stored in the memory 810. Examples of the processor 804 include, but are not limited to, circuitry, an fixed application-specific integrated circuit (ASIC) processor, a reduced instruction set computing (RISC) processor, a complex instruction set computing (CISC) processor, a field-programmable gate array (FPGA), a graphics processing unit and the like.

The memory 810 includes suitable logic, circuitry, and/or interfaces to store information of payment methods, validation methods, acquirers, and partner merchants. Examples of the memory 810 include a random-access memory (RAM), a read-only memory (ROM), a removable storage drive, a hard disk drive (HDD), a flash memory, a solid-state memory, and the like.

It will be apparent to a person skilled in the art that the scope of the some embodiments is not limited to realizing the memory 810 in the computing device 800, as described herein. In another embodiment, the memory 810 may be realized in a form of a database server or a cloud storage working in conjunction with the computing device 800.

The network interface 806 includes suitable logic, circuitry, and/or interfaces that transmits and receives data over communication networks using one or more communication network protocols under the control of the processor 804. The network interface 806 transmits/receives various requests from banks, account holders, mobile pay hosts, digital enablement service providers etc. Examples of the network interface 806 include, but are not limited to, an antenna, a radio frequency transceiver, a wireless transceiver, a Bluetooth transceiver, an ethernet port, a universal serial bus (USB) port, or any other device configured to transmit and receive data. The network interface 806 may receive first payment details associated first payment details of a bank account. The network interface 806 may provide the received data (e.g., first payment details) to other components, such as the processor 804.

The processor 804 may cause the first payment details to be received based on the second payment details as described herein. The processor 804 may present the first and second payment details to a user through display 802 and/or peripheral devices 816.

Additionally, in some embodiments, one or more of the illustrative components may be incorporated in, or otherwise form a portion of, another component. For example, the memory 810, or portions thereof, may be incorporated in the processor 804 in some embodiments. The computing device 800 may be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device.

The processor 804 may be embodied as any type of processor capable of performing the functions described herein. For example, the processor 804 may be embodied as a single or multi-core processor(s), digital signal processor, microcontroller, or other processor or processing/controlling circuit.

The memory 810 may be embodied as any type of volatile or non-volatile memory or data storage capable of performing the functions described herein. In operation, the memory 810 may store various data and software used during operation of the computing device 800 such as operating systems, applications, programs, libraries, and drivers. The memory 810 is communicatively coupled to the processor 804 via the I/O subsystem 812, which may be embodied as circuitry and/or components to facilitate input/output operations with the processor 804 the memory 810, and other components of the computing device 800.

The data storage device 814 may be embodied as any type of device or devices configured for short-term or long-term storage of data such as, for example, memory devices and circuits, memory cards, hard disk drives, solid-state drives, non-volatile flash memory, or other data storage devices. With respect to validation, the data storage device 814 may store data (e.g., computer code) to execute the processes and methods described herein. Alternatively, such data may be stored remotely. In some embodiments, the processor 804 or other hardware components may be configured to execute the processes and methods.

As shown, the computing device 800 may further include one or more peripheral devices 816. The peripheral devices 816 may include any number of additional input/output devices, interface devices, and/or other peripheral devices. For example, in some embodiments, the peripheral devices 816 may include a display, touch screen, graphics circuitry, keyboard, mouse, speaker system, microphone, network interface, and/or other input/output devices, interface devices, and/or peripheral devices. The computing device 800 may also perform one or more of the functions described in detail above.

As shown, the computing device 800 may further include a display 802. The display 802 may present details regarding various transactions to a user.

Techniques consistent with the present disclosure provide, among other features, systems and methods for processing payment transactions. While various exemplary embodiments of the disclosed system and method have been described above it should be understood that they have been presented for purposes of example only, not limitations. It is not exhaustive and does not limit the exemplary embodiments to the precise form disclosed.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments have been illustrated and described, it will be clear that the present disclosure is not limited to these embodiments only. Numerous modifications, changes, variations, substitutions, and equivalents will be apparent to those skilled in the art, without departing from the spirit and scope of the embodiments, as described in the claims.

What is claimed is:

1. A computing system, comprising:
one or more network interfaces; and
one or more processors that are configured to:
determine an absence of first details associated with a first electronic payment process;
identify a selection of second details by a user, wherein the second details are associated with a second electronic payment process, further wherein the second details are associated with the first details;
determine that the first details are to be retrieved based on the second details; and
cause at least part of the second details to be transmitted via the one or more network interfaces.

2. The computing system of claim 1, wherein the one or more processors are further to:
transmit, with the one or more network interfaces, the at least the part of the second details to one or more third-parties; and
receive, with the one or more network interfaces, the first details from the one or more third-parties.

3. The computing system of claim 2, wherein the one or more processors are further to:
authenticate the user;
in response to the user being authenticated, present the first details; and
in response to the user not being authenticated, disallow presentation of the first details.

4. The computing system of claim 2, wherein the one or more processors are further to:
present the first details;
identify a selection of the first details; and
cause a token to be transmitted to a third-party based on the selection of the first details.

5. The computing system of claim 1, wherein the one or more processors are further to:
receive third details associated with the second details; and
present the first details and the third details.

6. The computing system of claim 1, wherein the one or more processors are further to:
determine third details associated with the second electronic payment process; and
determine an order to present the second details and the third details based on usage parameters associated with the second details and the third details.

7. The computing system of claim 6, wherein the usage parameters include a frequency of payments based on the third details and a frequency of payments based on the second details.

8. At least one computer readable storage medium comprising a set of instructions, which when executed by a computing device, cause the computing device to:
determine an absence of first details associated with a first electronic payment process;
identify a selection of second details by a user, wherein the second details are associated with a second electronic payment process, further wherein the second details are associated with the first details;
determine that the first details are to be retrieved based on the second details; and
cause at least part of the second details to be transmitted.

9. The at least one computer readable storage medium of claim 8, wherein the instructions, when executed, cause the computing device to:
cause the at least the part of the second details to be transmitted to one or more third-parties; and
identify the first details from a communication transmitted by the one or more third-parties.

10. The at least one computer readable storage medium of claim 9, wherein the instructions, when executed, cause the computing device to:
authenticate the user;
in response to the user being authenticated, present the first details; and
in response to the user not being authenticated, disallow presentation of the first details.

11. The at least one computer readable storage medium of claim 9, wherein the instructions, when executed, cause the computing device to:
present the first details;
identify a selection of the first details; and
cause a token to be transmitted to a third-party based on the selection of the first details.

12. The at least one computer readable storage medium of claim 8, wherein the instructions, when executed, cause the computing device to:
receive third details associated with the second details; and
present the first details and the third details.

13. The at least one computer readable storage medium of claim 8, wherein the instructions, when executed, cause the computing device to:
determine third details associated with the second electronic payment process; and
determine an order to present the second details and the third details based on usage parameters associated with the second details and the third details.

14. The at least one computer readable storage medium of claim 13, wherein the usage parameters include a frequency of payments based on the third details and a frequency of payments based on the second details.

15. A method comprising:
determining an absence of first details associated with a first electronic payment process;
identifying a selection of second details by a user, wherein the second details are associated with a second electronic payment process, further wherein the second details are associated with the first details;
determining that the first details are to be retrieved based on the second details; and
causing at least part of the second details to be transmitted.

16. The method of claim 15, further comprising:
causing the at least the part of the second details to be transmitted to one or more third-parties; and
identifying the first details from a communication transmitted by the one or more third-parties.

17. The method of claim 16, further comprising:
authenticating the user;
in response to the user being authenticated, presenting the first details; and
in response to the user not being authenticated, disallowing presentation of the first details.

18. The method of claim 16, further comprising:
presenting the first details;
identifying a selection of the first details; and
causing a token to be transmitted to a third-party based on the selection of the first details.

19. The method of claim 15, further comprising:
determining third details associated with the second electronic payment process; and
determining an order to present the second details and the third details based on usage parameters associated with the second details and the third details.

20. The method of claim 19, wherein the usage parameters include a frequency of payments based on the third details and a frequency of payments based on the second details.
